(19) United States
(12) Patent Application Publication
(10) Pub. No.: US 2022/0010483 A1
(43) Pub. Date: Jan. 13, 2022

(54) COATING STRUCTURE OF BLACKOUT ADVERTISING CLOTH

(71) Applicant: TAYA CANVAS (SHANGHAI) COMPANY LIMITED, Shanghai (CA)

(72) Inventor: I-CHIEN LIN, SHANGHAI (CN)

(21) Appl. No.: 17/103,203

(22) Filed: Nov. 24, 2020

(30) Foreign Application Priority Data
Jul. 10, 2020 (TW) 109208813

(51) Int. Cl. D06N 3/04; D06N 3/00; G09F 7/00

(52) U.S. Cl. CPC D06N 3/042; D06N 3/0009; G09F 7/002; D06N 2201/02; D06N 2211/125; D06N 2209/067; D06N 2209/128; D06N 2209/0853; D06N 2203/041

(57) ABSTRACT

A coating structure of a blackout advertising cloth, comprising: a warp knitted mesh fabric; a front layer, which is an adhesive slurry layer made of polyacrylic resin as main component mixed with fireproof agent and waterproof agent, the adhesive slurry layer is coated on the front surface of the warp knitted mesh fabric for the slurry penetrating the meshes, so that the warp knitted mesh fabric and the front layer are firmly bonded; and a rear blackout layer, which is a shading slurry layer made of acrylic resin as main component mixed with blackout material, the rear blackout layer is coated on the rear surface, so that the warp knitted mesh fabric and the rear blackout layer are firmly bonded, and further form a coating structure of the blackout advertising cloth.

### BACKGROUND OF THE INVENTION

### 1. Field of the Invention

The invention relates to an advertising cloth, especially to one that takes a warp knitted fabric as foundation cloth and coated with a blackout material to form a blackout advertising cloth with a blackout layer structure.

### 2. Description of the Related Art

As FIG. 1 showing, a conventional manufacturing procedure of the advertising cloth 70, comprising: adding sodium hydroxide and lots of water to the factory cloth 71→desizing 72, adding H₂O₂, degreaser, bleaching agent, fluorescent whitening agent, and lots of water→rinsing, whitening 73→setting 74→front side coating 75→rear side foaming 76→blackout advertising cloth 77. The blackout advertising cloth 77 made with conventional manufacturing procedure can be complicated, and power wasted, also, the procedure of desizing, rinsing, and whitening produce lots of pollution. Therefore, the blackout advertising cloth 77 above mentioned is lack of practicality and environmental protection.

Also, the application of the conventional advertising cloth has below disadvantage:

1. Printing process: The dye-sublimation printing machine waste extremely huge energy, and the printing speed is extremely slow.

2. Printing difficulty: the temperature resistance of the rear foam layer is bad, and the foam layer is highly possibly melted due to the high temperature during dye-sublimation printing or latex printing.

3. Applicable usage: Only applicable indoor.

4. Storage period: The PU layer will be sticky and yellow after long term storage, and further influence the printing.

5: Biodegradability: Non Degradable.

Therefore, to solve the above mentioned problems and achieve environmental protection goal, the inventor develops a faster and power saving technology.

### SUMMARY OF THE INVENTION

It is a primary objective of the present invention to provide a coating structure of blackout advertising cloth, which manufacturing procedure is simplified and power saving, and does not need to add any chemicals in the procedure and does not cause water pollution.

In order to achieve the above objectives, the coating structure of blackout advertising cloth, comprising: a warp knitted mesh fabric, which is made of polyester fiber and has multiple meshes, and wherein the warp knitted mesh fabric further has a front surface and a rear surface; a front layer, which is an adhesive slurry layer made of polyacrylic resin as main component mixed with fireproof agent and waterproof agent, the adhesive slurry layer is coated on the front surface of the warp knitted mesh fabric for the slurry penetrating the meshes and covering the warp knitted mesh fabric, so that the warp knitted mesh fabric and the front layer are firmly bonded; a rear blackout layer, which is a shading slurry layer made of acrylic resin as main component mixed with blackout material, the rear blackout layer is coated on the rear surface of the warp knitted mesh fabric for the blackout material penetrating the meshes and covering the warp knitted mesh fabric, so that the warp knitted mesh fabric and the rear blackout layer are firmly bonded, and further form a coating structure of blackout advertising cloth.

With the features above disclosed, the present invention has below benefits comparing to the conventional advertising cloth:

1. Printing process: while using the UV printing machine and the latex printing machine, the power consumption is smaller, and the printing speed is faster than the conventional advertising cloth.

2. Printing difficulty: the present invention has nice temperature resistance which can endure temperature of printing by the latex printing machine.

3. Applicable usage: the present invention is anti-ultraviolet and waterproof, and applicable both indoor and outdoor.

4. Storage period: The PA layer is stable during long term storage and will not be sticky or yellow.

5: Biodegradability: Degradable.

Moreover, comparing to the conventional advertising cloth, the present invention has the benefits of simplified manufacturing procedure and power saving.

### BRIEF DESCRIPTION OF THE DRAWINGS

FIG. 1 is a schematic diagram illustrating manufacturing procedure according to the prior art;

FIG. 2 is a perspective view of the warp knitted fabric;

FIG. 3 is a zoom in view of the FIG. 2;

FIG. 4 is a sectional view of the applicable embodiment;

FIG. 5 is a sectional view along line 5-5 in FIG. 4;

FIG. 6 is perspective view of the application of the present invention;

FIG. 7 is side view of the application of the present invention;

FIG. 8 is a sectional view of the mark 8 section in the FIG. 7.

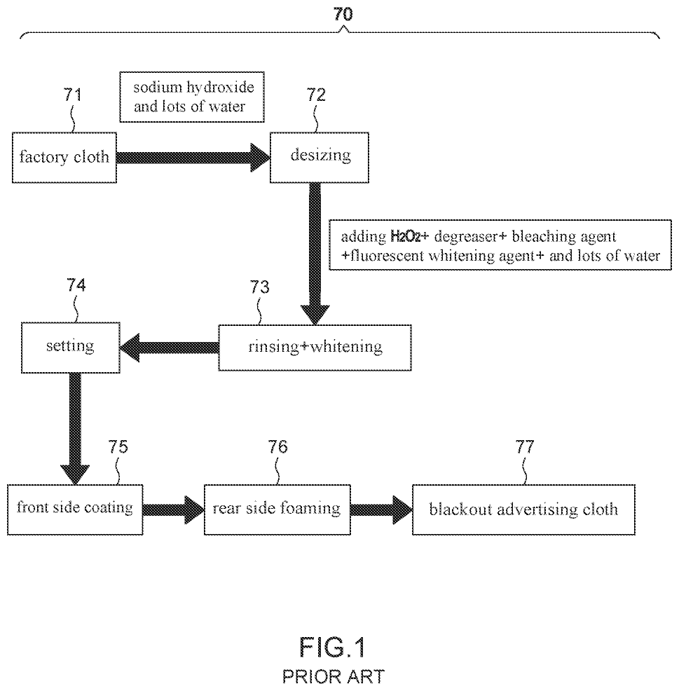

### DETAILED DESCRIPTION OF THE PREFERRED EMBODIMENT

For better understanding of present invention, I provide the embodiment and drawing enclosed for detailed description. Those who skilled in the art can understand purpose, the feature and benefit of the present invention from the contents disclosed in this specification. Kindly noted that the present invention can be implemented or applied through other different specific embodiments and based on different viewpoints various details in this specification can be various changed without departing from the spirit of the present invention. In addition, the drawings attached to the present invention are merely a schematic illustration and they are not depicted in actual dimensions. The following embodiments will further describe the related technical content of the present invention in detail, but the disclosed content is not intended to limit the technical scope of the present invention.

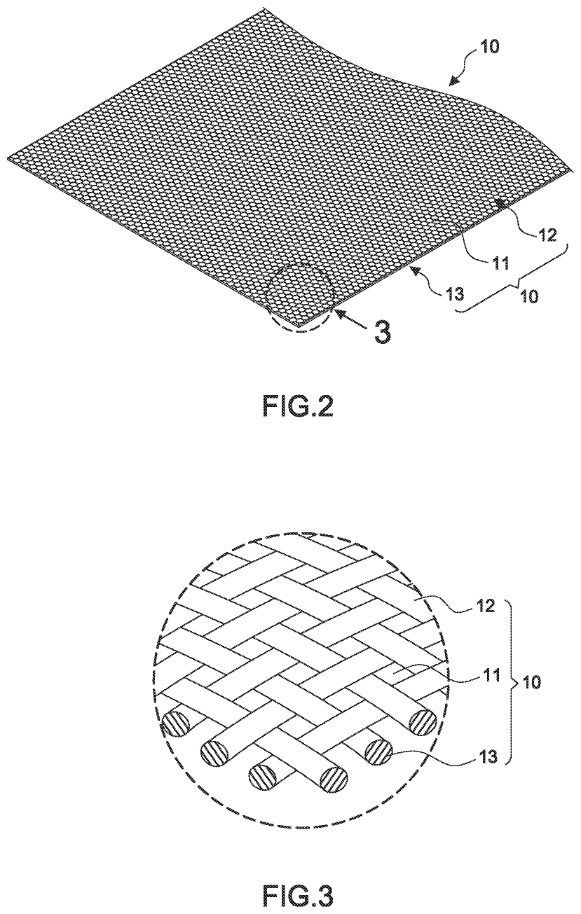

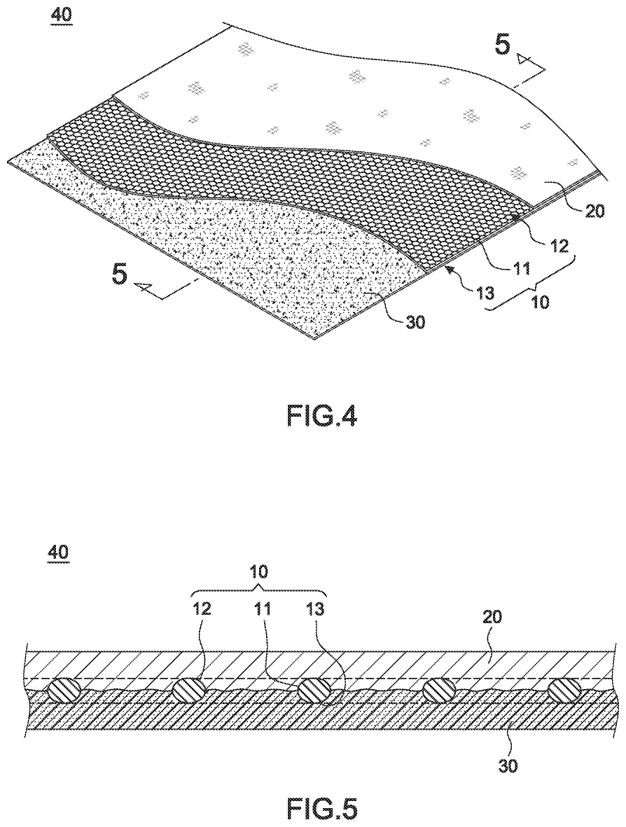

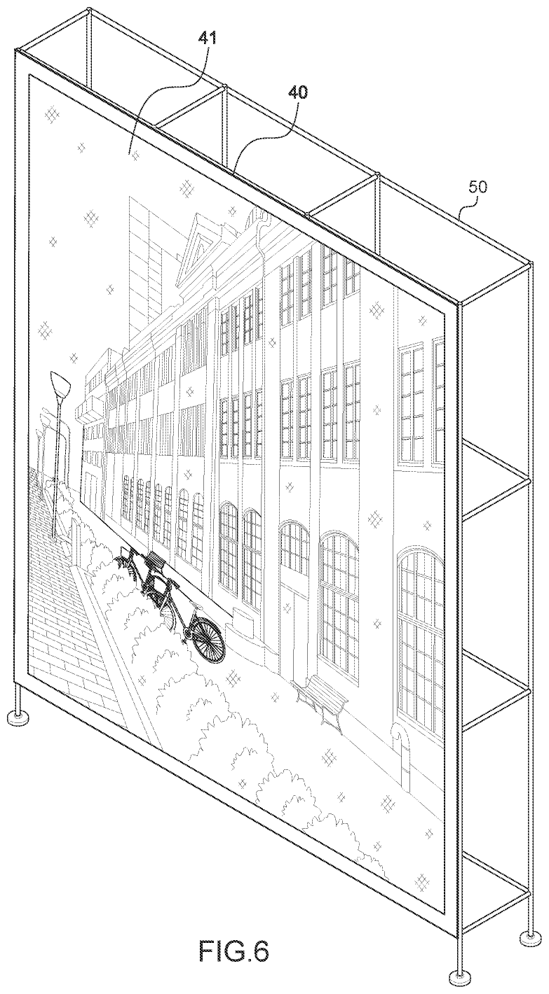

Referring to FIGS. 2-8, in a first applicable embodiment, a coating structure of blackout advertising cloth 40, comprising a warp knitted mesh fabric 10, which is made of polyester fiber and has multiple meshes, and wherein the warp knitted mesh fabric 10 further has a front surface 12 and a rear surface 13, as FIGS. 2-3 showing; Furthermore, the warp knitted mesh fabric 10 is not made of PVC material. In this embodiment, the basic weight of the warp knitted mesh fabric 10 is about 158˜178 g/m², in better situation is about 166˜170 g/m², in best situation is 168 g/m².

A front layer 20, which is an adhesive slurry layer made of polyacrylic resin as main component mixed with fireproof agent and waterproof agent, the adhesive slurry layer is coated on the front surface 12 of the warp knitted mesh fabric 10 for the slurry penetrating the meshes 11 and covering the warp knitted mesh fabric 10, so that the warp knitted mesh fabric 10 and the front layer 20 are firmly bonded; in this embodiment, the front layer 20 is an adhesive slurry layer which can be coated on the warp knitted mesh fabric 10 by a coating machine, and be firmly bonded on the warp knitted mesh fabric 10 after drying. In this embodiment, the basic weight of the front layer 20 is about 65˜85 g/m², in better situation is about 73˜77 g/m², in best situation is 75 g/m².

A rear blackout layer 30, which is a shading slurry layer made of acrylic resin as main component mixed with blackout material, the rear blackout layer 30 is coated on the rear surface 13 of the warp knitted mesh fabric 10 for the blackout material penetrating the meshes 11 and covering the warp knitted mesh fabric 10, so that the warp knitted mesh fabric 10 and the rear blackout layer 30 are firmly bonded, therefore, the front surface 12 and the rear surface 13 of the warp knitted mesh fabric 10 are covered by the front layer 20 and the rear blackout layer 30, and further form a coating structure of the blackout advertising cloth 40. In this embodiment, the basic weight of rear blackout layer 30 is about 65˜85 g/m², in better situation is about 73˜77 g/m², in best situation is 75 g/m².

In this embodiment, the rear blackout layer 30 can be coated by the scraper, the rolling machine, and any other coating machine, coating the front layer 20 on the warp knitted mesh fabric 10, by oven dry and air dry make the front layer 20 be bonded on the warp knitted mesh fabric 10. The feature coating machine belongs to the prior art and is not the subject of the present invention. Therefore, their details are not discussed here.

The warp knitted mesh fabric 10 used in the blackout advertising cloth 40 of the present invention has high-density meshes 11, and the polyacrylic resin of the front layer 20 is a non-toxic, odorless, tasteless, and milk-white highly crystalline polymer, the polyacrylic resin is one of the lightest plastics with a density of only 0.90 to 0.91 g/cm3, which is only 60% of the PVC density. Among the general-purpose plastics, polyacrylics have the best heat resistance with a heat resistance of 80° to 100° C., nice resistance to stress cracks, a long flex fatigue life and has the feature of ink-absorbing. In addition, the rear blackout layer 30 is mainly made of acrylic resin, in this embodiment, the weight ratio of the front layer 20, the warp knitted mesh fabric 10 and the rear blackout layer 30 are 75:158:75; therefore, the blackout advertising cloth 40 arranged on the warp knitted mesh fabric 10 forms a composite structure with features of a fireproof, waterproof and ink-absorbing layer.

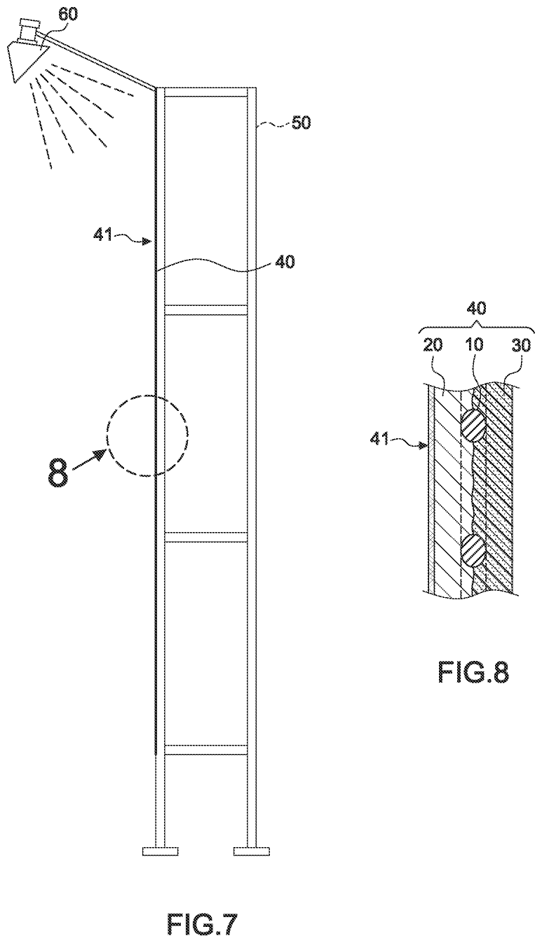

Referring to FIGS. 7-8, the outdoor application of the present invention is disclosed, the front surface of the blackout advertising cloth 40 can be printed by an advertising ink 41, when a light source 60 hit the light on the front surface of the blackout advertising cloth 40, by the blackout feature providing from the rear blackout layer 30 of the warp knitted mesh fabric 10, the supporting frame 50 would be fully hidden instead of being saw the shape or shadow of the frame showing on the advertising cloth 40 and affecting the effectiveness of advertising, therefore, the present invention is suitable for outdoor usage.

The present invention has the following features and effects that need to be clarified:

The blackout advertising cloth 40 of the present invention reached the fire protection level “Class B” in the European fire protection standards EN13501-1-B-s1-d0.

Also, the blackout advertising cloth 40 is coated by a coating machine with the front layer 20 and the shading slurry layer 30 on the warp knitted mesh fabric 10 for the slurry penetrating the meshes 11 and covering the warp knitted mesh fabric 10, and after oven dry and air dry, the layers are firmly bounded on the warp knitted mesh fabric 10, so as to form a composite structure with features of a fireproof and waterproof layer on the warp knitted mesh fabric 10. Moreover, the coating of the rear blackout layer 30 can be done in only one procedure instead of conventional complicated process, and improves the industrial availability, economy, and practicality.

Also, the blackout advertising cloth 40 takes a warp knitted fabric 10 as foundation cloth, it has the features of non PVC material and non-toxic, so is suitable for indoor usage and fits the medical requirement.

Also, the blackout advertising cloth 40 is burnable, can be buried in landfill site, the coating is degradable; the presentation invention will not cause any hazardous substance during burning, the dioxin and hydrogen chloride produced during burning is lower that the EU standard; and the front layer 20 and the rear blackout layer 30 are degradable, and the warp knitted fabric 10 will not cause any pollution during landfill. Below is the table of comparison of the procedure of the present invention and the conventional advertising cloth:

| | Manufacturing | | Water | Energy |
|---|---|---|---|---|
| | procedure | Chemicals | pollution | consumption |
| conventional | complicated | desizing, | required lots | Huge energy |
| advertising | | rinsing, | of water | consumption |
| cloth | | whitening | during | |
| | | | desizing, | |
| | | | rinsing, | |
| | | | whitening | |
| advertising | Only one | non | non | Only one |
| cloth of the | procedure | | | procedure with |
| present | | | | low energy |
| invention | | | | consumption |

Below is the table of comparison of the application of the present invention and the conventional advertising cloth:

| | | Printing | Applicable | | |
|---|---|---|---|---|---|
| | Printing process | difficulty | usage | Storage period | Biodegradability |
| conventional | The | The | Only | The PU layer | Non |
| advertising | dye-sublimation | temperature | applicable | will be sticky | Degradable. |
| cloth | printing machine: | resistance of | indoor. | and yellow | |
| | waste extremely | the rear | | after long term | |
| | huge energy, and | foam layer is | | storage, and | |
| | the printing speed | bad, the | | further | |
| | is extremely slow; | foam layer is | | influence the | |
| | The UV printing | highly | | printing. | |
| | machine: the | possibly | | | |
| | printing speed is | melted due | | | |
| | faster, the power | to the high | | | |
| | consumption is | temperature | | | |
| | lower; | during dye- | | | |
| | The latex printing | sublimation | | | |
| | machine: the | printing | | | |
| | power | or latex | | | |
| | consumption is | printing. | | | |
| | still huge, and the | | | | |
| | printing speed is | | | | |
| | medium. | | | | |
| advertising | the UV printing | the present | the present | The PA layer is | Degradable |
| cloth of the | machine and the | invention | invention is | stable during | |
| present | latex printing | has nice | anti-ultraviolet | long term | |
| invention | machine: the | temperature | and waterproof, | storage and | |
| | power | resistance ° | and applicable | will not be | |
| | consumption is | | both indoor | sticky or | |
| | smaller, and the | | and outdoor. | yellow. | |
| | printing speed is | | | | |
| | faster than the | | | | |
| | conventional | | | | |
| | advertising cloth. | | | | |

With reference to the above comparison table, the advertising cloth 40 of the present invention has below improved features:

1. Printing process: while using the UV printing machine and the latex printing machine, the power consumption is smaller, and the printing speed is faster than the conventional advertising cloth using Dye sub printing machine.

2. Printing difficulty: the present invention has nice temperature resistance.

3. Applicable usage: the present invention is anti-ultraviolet and waterproof, and applicable both indoor and outdoor.

4. Storage period: The PA layer is stable during long term storage and will not be sticky or yellow.

5: Biodegradability: Degradable.

Moreover, comparing to the conventional advertising cloth, the present invention has the benefits of simplified manufacturing procedure and power saving.

The invention step of the blackout advertising cloth 40 of the present invention is non-obviousness, and has remarkable features that can provide better technique than prior art.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A coating structure of a blackout advertising cloth, comprising:
a warp knitted mesh fabric, which is made of polyester fiber and has multiple meshes, wherein the warp knitted mesh fabric further has a front surface and a rear surface;
a front layer, which is an adhesive slurry layer made of polyacrylic resin as main component mixed with fireproof agent and waterproof agent, the adhesive slurry layer is coated on the front surface of the warp knitted mesh fabric for the slurry penetrating the meshes and covering the warp knitted mesh fabric, so that the warp knitted mesh fabric and the front layer are firmly bonded; and
a rear blackout layer, which is a shading slurry layer made of acrylic resin as main component mixed with blackout material, the rear blackout layer is coated on the rear surface of the warp knitted mesh fabric for the blackout material penetrating the meshes and covering the warp knitted mesh fabric, so that the warp knitted mesh fabric and the rear blackout layer are firmly bonded, and further form a coating structure of the blackout advertising cloth.

2. The coating structure of a blackout advertising cloth as claim in claim 1, wherein the basic weight of the warp knitted mesh fabric is about 158˜178 g/m², in better situation is about 166˜170 g/m², in best situation is 168 g/m².

3. The coating structure of a blackout advertising cloth as claim in claim 1, wherein the front layer and the rear blackout layer is about 65˜85 g/m², in better situation is about 73˜77 g/m², in best situation is 75 g/m².
